(19) United States
(12) Patent Application Publication
(10) Pub. No.: US 2006/0199892 A1
(43) Pub. Date: Sep. 7, 2006

(54) Method for producing monodisperse gel-type ion exchangers

(76) Inventors: Wolfgang Podszun, Koln (DE); Reinhold Klipper, Koln (DE); Dmitry Chernyshov, Moscow (RU)

Correspondence Address: Law & Intellectual Property Dept.;Lanxess Corporation, 111 Ridc Park West Drive, Pittsburgh, PA, 15275-1112, US

(21) Appl. No.: 10/524,923

(22) PCT Filed: Aug. 2, 2003
(86) PCT No.: PCT/EP03/08600

§ 371 Date: Feb. 14, 2006

(30) Foreign Application Priority Data
Aug. 16, 2002 (DE) 102 37 601.8

(51) Int. Cl. C08F 2/16

(52) U.S. Cl. 524/458; 525/333.9

(57) ABSTRACT

The invention relates to a process for producing monodisperse ion-exchanger gels with a particle size of from 5 to 500 μm, obtainable via a) production of a non-crosslinked monodisperse seed polymer with a particle size of from 0.5 to 20 μm via free-radical-initiated polymerization of monoethylenically unsaturated compounds in the presence of a non-aqueous solvent, b) addition of an active styrene-containing monomer mixture as feed to this seed polymer, permitting the monomer mixture to penetrate into and swell the seed, and polymerizing the mixture at an elevated temperature, if appropriate with one or more repetitions of the steps of addition of monomer mixture, penetration and swelling, and polymerization, and where during the final addition the monomer mixture comprises from 2 to 50% by weight of crosslinking agent, and c) functionalization by means of a sulfonating agent to give cation exchangers or via amidomethylation with subsequent hydrolysis to give anion exchangers, or chloromethylation with subsequent amination.

The invention relates to a process for producing monodisperse ion-exchanger gels with a particle size of from 5 to 500 μm.

Ion exchangers are generally obtained via functionalization of crosslinked styrene bead polymers. For example, to produce cation exchangers, covalently bonded sulfonic acid groups are produced via reaction of aromatic units of the polymer skeleton with a sulfonating agent, e.g. sulfuric acid. Anion exchangers contain covalently bonded amino groups or ammonium groups and these may be produced via chloromethylation and subsequent amination, for example.

In recent times, increasing importance has been placed on ion exchangers with very uniform particle size (hereinafter termed “monodisperse”), since the more advantageous hydrodynamic properties of an exchanger bed composed of monodisperse ion exchangers can achieve cost advantages in many applications. Monodisperse ion exchangers can be obtained by functionalizing monodisperse bead polymers.

One way of producing monodisperse bead polymers is known as the seed/feed process, in which monodisperse bead polymer (“seed”) is swollen in the monomer, which is then polymerized. These seed/feed processes are described in EP 0 098 130 B1, and EP 0 101 943 B1, for example.

EP-A 826 704 discloses a seed/feed process in which microencapsulated crosslinked bead polymer is used as seed.

One problem with the known processes for producing monodisperse ion exchangers via seed/feed technology is the provision of monodisperse seed. A method often used is fractionation of bead polymers with conventional, i.e. broad, particle size distribution. A disadvantage of this process is that as monodispersity rises the yield of the desired target fraction falls markedly during the sieving process.

Monodisperse bead polymers can be produced in a controlled manner via spraying techniques. By way of example, EP 0 046 535 B1 and EP 0 051 210 B2 describe spraying processes suitable for ion exchangers. A feature common to these spraying processes is their very high engineering cost. The spraying processes generally give ion exchangers with a particle size of from 500 to 1200 μm. Ion exchangers with smaller particle sizes cannot be produced, or can be produced only at markedly great cost.

EP 0 448 391 B1 discloses a process for producing polymer particles of uniform particle size in the range from 1 to 50 μm. The seed used in this process comprises an emulsion polymer whose particle sizes are preferably from 0.05 to 0.5 μm.

U.S. Pat. No. 6 239 224 B1 describes a seed/feed process for producing expandable polystyrene beads with a particle size of at least 200 μm.

EP 0 288 006 B1 discloses crosslinked monodisperse bead polymers with a particle size of from 1 to 30 μm. These bead polymers are obtained via a seed/feed process in which crosslinked seed particles are used.

Although numerous methods and processes for preparing monodisperse bead polymers and, respectively, monodisperse ion exchangers have previously been described, there is not currently any practicable process for the controlled production of monodisperse ion exchangers with a particle size of from 5 to 500 μm.

The present invention provides a process for producing monodisperse ion-exchanger gels with a particle size of from 5 to 500 μm, characterized in that
a) a non-crosslinked monodisperse seed polymer with a particle size of from 0.5 to 20 μm is produced via free-radical-initiated polymerization of monoethylenically unsaturated compounds in the presence of a non-aqueous solvent,
b) an activated styrene-containing monomer mixture is added as feed to this seed polymer, the monomer mixture is permitted to penetrate and swell the seed, and the mixture is polymerized at an elevated temperature, and the steps of addition of monomer mixture, penetration and swelling, and polymerization are, if appropriate, repeated one or more times, and where during the final addition the monomer mixture comprises from 2 to 50% by weight of crosslinking agent, and
c) the resultant polymer is converted via functionalization into ion exchanger.

The particle size of the inventive ion exchangers is from 5 to 500 μm, preferably from 10 to 400 μm, particularly preferably from 20 to 300 μm. Conventional methods, such as screen analysis or image analysis, are suitable for determining the average particle size and the particle size distribution. The ratio of the 90% value (Ø (90)) and the 10% value (Ø (10)) of the volume distribution is taken as measure of the width of the particle size distribution of the inventive ion exchangers. The 90% value (Ø (90)) gives the diameter which is greater than the diameter of 90% of the particles. Correspondingly, 10% of the particles have a diameter smaller than that of the 10% value (Ø (10)). For the purposes of the invention, monodisperse particle size distributions mean Ø (90)/Ø (10)≦1.5, preferably Ø (90)/Ø (10)≦1.25.

For preparation of the non-crosslinked seed polymer in step a) of the process, use is made of monoethylenically unsaturated compounds, but no polyethylenically unsaturated compounds or, respectively, crosslinking agents are used.

For the purposes of the present invention, monoethylenically unsaturated compounds are: styrene, vinyltoluene, alpha-methylstyrene, chlorostyrene, esters of acrylic acid or methacrylic acid, e.g. methyl methacrylate, ethyl methacrylate, ethyl acrylate, isopropyl methacrylate, butyl acrylate, butyl methacrylate, hexyl methacrylate, 2-ethylhexyl acrylate, ethylhexyl methacrylate, decyl methacrylate, dodecyl methacrylate, stearyl methacrylate, or isobornyl methacrylate. It is preferable to use styrene, methyl acrylate or butyl acrylate. Mixtures of different monethylenically unsaturated compounds also have good suitability.

In the preparation of the non-crosslinked seed polymer, the abovementioned monoethylenically unsaturated compound(s) is/are polymerized in the presence of a non-aqueous solvent, using an initiator.

Non-aqueous solvents suitable in the invention are dioxane, acetone, acetonitrile, dimethylformamide, or alcohols. Preference is given to alcohols, in particular methanol, ethanol, n-propanol, isopropanol, n-butanol, isobutanol, and tert-butanol. Mixtures of different solvents also have good suitability, in particular mixtures of different alcohols. The alcohols may, if appropriate, also comprise up to 50% by weight of water, preferably up to 25% by weight of water. If solvent mixtures are used, concomitant use may also be made of non-polar solvents, in particular hydrocarbons, such as hexane, heptane, and toluene, in proportions of up to 50% by weight.

The ratio of monoethylenically unsaturated compounds to solvent is from 1:2 to 1:30, preferably from 1:3 to 1:15.

The seed polymer is preferably prepared in the presence of a high-molecular-weight dispersing agent dissolved in the solvent.

Suitable high-molecular-weight dispersing agents are natural or synthetic macromolecular compounds. Examples are cellulose derivatives, such as methylcellulose, ethylcellulose, hydroxypropylcellulose, polyvinyl acetate, partially hydrolyzed polyvinyl acetate, polyvinylpyrrolidone, copolymers of vinylpyrrolidone and vinyl acetate, and copolymers of styrene and maleic anhydride. Polyvinylpyrrolidone is preferred in the invention. The content of high-molecular-weight dispersing agent is from 0.1 to 20% by weight, preferably from 0.2 to 10% by weight, based on the solvent.

In addition to the dispersing agent, use may also be made of ionic and non-ionic surfactants. Examples of suitable surfactants are the sodium salt of sulfosuccinic acid, methyltricaprylammonium chloride, or ethoxylated nonylphenols. Preference is given to ethoxylated nonylphenols having from 4 to 20 ethylene oxide units. The amounts which may be used of the surfactants are from 0.1 to 2% by weight based on the solvent.

Initiators suitable for preparation of the seed polymer are compounds which form free radicals when the temperature is increased. Examples which may be mentioned are: peroxy compounds, such as dibenzoyl peroxide, dilauroyl peroxide, bis(p-chlorobenzoyl) peroxide, dicyclohexyl peroxydicarbonate, or tert-amylperoxy-2-ethylhexane, and also azo compounds, such as 2,2′-azobis(isobutyronitrile) or 2,2′-azobis(2-methylisobutyronitrile). If the solvent comprises a proportion of water, another suitable initiator is sodium peroxydisulfate or potassium peroxydisulfate.

Aliphatic peroxy esters also have good suitability. Examples of these are tert-butyl peroxyacetate, tert-butyl peroxyisobutyrate, tert-butyl peroxypivalate, tert-butyl peroxyoctoate, tert-butyl 2-ethylperoxyhexanonate, tert-butyl peroxyneodecanoate, tert-amyl peroxypivalate, tert-amyl peroxyoctoate, tert-amyl 2-ethylperoxy-hexanonate, tert-amyl peroxyneodecanoate, 2,5-bis(2-ethylhexanoylperoxy)-2,5-dimethylhexane, 2,5-dipivaloyl-2,5-dimethylhexane, 2,5-bis(2-neodecanoyl-peroxy)-2,5-dimethylhexane, di-tert.-butyl peroxyazelate, or di-tert-amyl peroxyazelate.

The amounts generally used of the initiators are from 0.05 to 6.0% by weight, preferably from 0.2 to 4.0% by weight, based on the monoethylenically unsaturated compound(s).

Use may be made of inhibitors soluble in the solvent. Examples of suitable inhibitors are phenolic compounds, such as hydroquinone, hydroquinone monomethyl ether, resorcinol, pyrocatechol, tert-butylpyrocatechol, condensates of phenols with aldehydes. Other organic inhibitors are nitrogen-containing compounds, e.g. diethylhydroxylamine and isopropylhydroxylamine. Resorcinol is preferred as inhibitor. The concentration of the inhibitor is from 0.01 to 5% by weight, preferably from 0.1 to 2% by weight, based on the monoethylenically unsaturated compounds.

The polymerization temperature depends on the decomposition temperature of the initiator, and also on the boiling point of the solvent, and is typically in the range from 50 to 150° C., preferably from 60 to 120° C. It is advantageous to polymerize at the boiling point of the solvent with continuous stirring by a gate stirrer. Low stirrer speeds are used. By way of example, the stirrer speed for a gate stirrer in 4-liter laboratory reactors is from 50 to 250 rpm, preferably from 100 to 150 (rmp=revolutions per minute).

The polymerization time is generally two or more hours, e.g. from 2 to 30 hours.

The seed polymers produced in step a) of the process of the invention are highly monodisperse and have particle sizes of from 0.5 to 20 μm, preferably from 2 to 15 μm. In the context of the present work it has been found that the particle size can be influenced via the selection of the solvent, inter alia. For example, higher alcohols, such as n-propanol, isopropanol, n-butanol, isobutanol, and tert-butanol, give larger particle sizes than methanol. The particle size can be shifted to lower values via a proportion of water or hexane in the solvent. Addition of toluene increases the particle size.

The seed polymer may be isolated via conventional methods, such as sedimentation, centrifuging, or filtration. The product is washed with alcohol and/or water to remove the dispersing agent, and is dried.

In step b) of the process, the seed polymer is treated with an activated styrene-containing monomer mixture as feed. In the present context, styrene-containing means that the mixture comprises from 50 to 99.9% by weight, preferably from 80 to 99.9% by weight, of styrene. The other constituents of the mixture are comonomer, crosslinking agent, and initiator for the activation process.

Suitable comonomers are compounds copolymerizable with styrene, e.g. methyl methacrylate, ethyl methacrylate, ethyl acrylate, hydroxyethyl methacrylate, or acrylonitrile.

Crosslinking agents are compounds having two or more polymerizable olefinically unsaturated double bonds in the molecule. By way of example, mention may be made of divinylbenzene, allyl methacrylate, ethylene glycol dimethacrylate, butanediol dimethacrylate, trimethylolpropane triacrylate, butanediol divinyl ether, and octadiene. Divinylbenzene is preferred. The divinylbenzene used may be of commercially available quality, comprising ethylvinylbenzene alongside the isomers of divinylbenzene.

Initiators which may be used for step b) of the process are the free-radical generators described in step a) of the process. The amounts generally used of the initiators are from 0.1 to 4.0% by weight, preferably from 0.5 to 2.5% by weight, based on the monomer mixture. Mixtures of the abovementioned free-radical generators may, of course, also be used, examples being mixtures of initiators with different decomposition temperatures.

The ratio by weight of seed polymer to monomer mixture is from 1:1 to 1:1000, preferably from 1:2 to 1:100, particularly preferably from 1:3 to 1:30.

The general manner of addition of the monomer mixture to the seed polymer is that an aqueous emulsion of the monomer mixture is added to an aqueous dispersion of the seed polymer. Materials having good suitability are fine-particle emulsions with average particle sizes of from 1 to 10 μm which can be prepared with the aid of rotor-stator mixers or mixing jets, using an emulsifying agent, e.g. the sodium salt of isooctyl sulfosuccinate.

The monomer mixture may be added at temperatures below the decomposition temperature of the initiator, for example at room temperature. It is advantageous for the emulsion comprising the monomer mixture to be metered in over a relatively long period, e.g. over from 0.25 to 3 hours, with stirring. Once all of the emulsion has been added stirring is continued until the monomer has penetrated completely into the seed particles. This generally takes from 0.5 to 2 hours and can be monitored in a simple manner via inspection of a specimen under an optical microscope. The amounts of water used during preparation of the seed polymer suspension and monomer mixture emulsion are non-critical within wide limits. Suspensions and, respectively, emulsions of from 10 to 50% strength are generally used.

The resultant mixture composed of seed polymer, monomer mixture, and water is treated with at least one dispersing agent, suitable materials here being natural or synthetic water-soluble polymers, e.g. gelatin, starch, polyvinyl alcohol, polyvinylpyrrolidone, polyacrylic acid, polymethacrylic acid, or copolymers of (meth)acrylic acid or of (meth)acrylic esters. Other materials with very good suitability are cellulose derivatives, in particular cellulose esters or cellulose ethers, such as carboxymethylcellulose or hydroethylcellulose. The amount used of the dispersing agents is generally from 0.05 to 1%, preferably from 0.1 to 0.5%, based on the aqueous phase.

The aqueous phase may moreover comprise a buffer system which sets the pH of the aqueous phase to a value of from 12 to 3, preferably of from 10 to 4. Buffer systems having particularly good suitability comprise phosphate salts, acetate salts, citrate salts, or borate salts.

It can be advantageous to use an inhibitor dissolved in the aqueous phase. Inhibitors which may be used are either inorganic or organic substances. Examples of inorganic inhibitors are nitrogen compounds, such as hydroxylamine, hydrazine, sodium nitrite, and potassium nitrite. Examples of organic inhibitors are phenolic compounds, such as hydroquinone, hydroquinone monomethyl ether, resorcinol, pyrocatechol, tert-butylpyrocatechol, condensates of phenols with aldehydes. Other organic inhibitors are nitrogen-containing compounds, e.g. diethylhydroxylamine or isopropyl-hydroxylamine. Resorcinol is preferred as inhibitor in the invention. The concentration of the inhibitor is from 5 to 1000 ppm, preferably from 10 to 500 ppm, particularly preferably from 20 to 250 ppm, based on the aqueous phase.

The polymerization of the monomer mixture that has entered and swollen the seed particles is induced via temperature increase to the decomposition temperature of the initiator, generally from 60 to 130° C. The polymerization takes two or more hours, e.g. from 3 to 10 hours.

In one particular embodiment of the present invention, the monomer mixture is added over a relatively long period of from 1 to 6 hours at a temperature at which at least one of the initiators used is active. Temperatures used in this procedure are generally from 60 to 130° C., preferably from 60 to 95° C.

The feed step, i.e. addition of monomer mixture, permitting penetration and swelling of the materials, and polymerization, may be repeated once or two or more times, e.g. from 2 to 10 times. This means that the product produced in a previous feed step is used as seed polymer for the subsequent feed step. Repetition of the feed steps two or more times can finally give monodisperse polymers with particle sizes of up to 500 μm, from monodisperse seed polymers with particle sizes of from 0.5 to 20 μm. The enlargement factor here is calculated from the ratio by weight of seed polymer to monomer mixture. This in turn is from 1:1 to 1 :1000, preferably from 1:2 to 1:100, particularly preferably from 1:3 to 1:30.

For the purposes of the present invention, it has been found that the content of crosslinking agent in the monomer mixture is important for high monodispersity of the resultant ion exchangers. If the feed steps are repeated two or more times, crosslinking agent is used only in the final feed step. The amount of crosslinking agent in the final feed step is from 2 to 50% by weight, preferably from 3 to 20% by weight, based in each case on the added activated styrene-containing monomer mixture.

After the polymerization process, the polymer formed may be isolated using the usual methods, e.g. by filtration or decanting, and dried, if appropriate after one or more washes, and may, if desired, be sieved.

Known processes may be used to convert the polymer from step b) of the process to the ion exchanger in step c) of the process. For example, cation exchangers are prepared via sulfonation. Suitable sulfonating agents here are sulfuric acid, sulfur trioxide, and chlorosulfonic acid. It is preferable to use sulfuric acid whose concentration is from 90 to 100%, particularly preferably from 96 to 99%. The sulfonation temperature is generally from 50 to 200° C., preferably from 90 to 130° C. If desired, a swelling agent may be used during the sulfonation process, examples being chlorobenzene, dichloroethane, dichloropropane, or methylene chloride.

The reaction mixture is stirred during the sulfonation process. Various types of stirrer may be used here, examples being blade, anchor, gate, or turbine stirrer. A double turbine stirrer generating radial movement of the material has been found to have particularly good suitability.

After the sulfonation process, the reaction mixture composed of sulfonation product and residual acid is cooled to room temperature and diluted, first with sulfuric acids of reducing concentrations and then with water.

If desired, the cation exchanger obtained in the invention in the H form can be treated with demineralized water at temperatures of from 70 to 145° C., preferably from 105 to 130° C, for purification.

For many applications it is advantageous to convert the cation exchanger from the acidic form into the sodium form. This conversion takes place using sodium hydroxide solution whose concentration is from 10 to 60%, preferably from 40 to 50%. For the purposes of the present invention, it has been found that the conversion temperature is important. At conversion temperatures of from 60 to 120° C., preferably from 75 to 100° C., it has been found that no defects arise on the ion exchanger beads, and that the level of purity is particularly high.

Anion exchangers can, by way of example be obtained via amidoalkylation of the polymer from step b) of the process and subsequent hydrolysis. Amidoalkylating agents having particularly good suitability are N-hydroxymethylphthalimide and bis(phthalimidomethyl)ether.

This reaction gives aminomethylated crosslinked polystyrene bead polymers which are weakly basic anion exchangers.

These weakly basic anion exchangers may be converted into anion exchangers of moderate basicity via reaction with formic acid/formaldehyde in the Leuckart[Wallach reaction, or into strongly basic anion exchangers via quaternization with alkyl halides, such as chloromethane or ethyl chloride.

Anion exchangers may also be prepared via haloalkylation of the polymer from step b) of the process and subsequent amination. A preferred haloalkylating agent is chloromethyl methyl ether. Weakly basic anion exchangers can be obtained from the haloalkylated polymers via reaction with a secondary amine, such as dimethylamine. Correspondingly, the reaction of the haloalkylated polymers with tertiary amines, such as trimethylamine, dimethylisopropylamine, or dimethylaminoethanol, gives strongly basic anion exchangers.

Simple preparation of chelating resins is also possible from the inventive polymers. For example, reaction of a haloalkylated polymer with iminodiacetic acid gives chelating resins of iminodiacetic acid type.

The ion exchangers obtained by the inventive process feature high monodispersity, and particularly high stability, and purity.

Appropriate functionalization gives the inventive monodisperse cation exchanger gels or monodisperse anion exchanger gels with particle sizes of from 5 to 500 μm.

The invention therefore provides monodisperse anion exchanger gels or monodisperse cation exchanger gels with a particle size of from 5 to 500 μm, obtainable via
a) production of a non-crosslinked monodisperse seed polymer with a particle size of from 0.5 to 20 μm via free-radical-initiated polymerization of monoethylenically unsaturated compounds in the presence of a non-aqueous solvent,
b) addition of an active styrene-containing monomer mixture as feed to this seed polymer, permitting the monomer mixture to penetrate into and swell the seed, and polymerizing the mixture at an elevated temperature, if appropriate with one or more repetitions of the steps of addition of monomer mixture, penetration and swelling, and polymerization, and where during the final addition the monomer mixture comprises from 2 to 50% by weight of crosslinking agent, and
c) functionalization by means of a sulfonating agent to give cation exchangers or via amidomethylation with subsequent hydrolysis or via chloromethylation with subsequent amination to give anion exchangers.

The anion exchangers prepared in the invention are used
to remove anions from aqueous or organic solutions or from their vapors
to remove anions from condensates
to remove color particles from aqueous or organic solutions or from their vapors
to decolorize and demineralize glucose solutions, whey, dilute gelatin-containing solutions, fruit juices, fruit must products, and sugars, preferably of mono- or disaccharides, in particular cane sugar, beet sugar solutions, fructose solutions, for example in the sugar industry, dairies, the starch industry, and the pharmaceutical industry,
to remove organic components from aqueous solutions, for example humic acids from surface water.

The inventive anion exchangers may moreover be used for purification and treatment of water in the chemical industry and electronics industry, in particular for production of very high purity water.

The inventive anion exchangers may moreover be used in combination with cation exchangers of gel and/or macroporous type for demineralization of aqueous solutions and/or condensates, in particular in the sugar industry.

There is a wide variety of different applications for the cation exchangers prepared in the invention. For example, they are also used in treatment of drinking water, in production of very high purity water (needed in microchip production for the computer industry), for chromatographic separation of glucose and fructose, and as catalysts for various chemical reactions (e.g. in preparation of bisphenol A from phenol and acetone). For most of these applications it is desirable that the cation exchangers perform the tasks for which they are intended without release into their environment of impurities which may derive from their production or which may be produced via polymer degradation during use. The presence of impurities in the water emerging from the cation exchanger is discernible via an increase in the conductivity of the water and/or in its content of organic carbon (TOC content).

The inventive cation exchangers also have excellent suitability for the demineralization of water. No increased conductivity is observed even after prolonged operating times of the desalination plants. Although the structure-property correlation for the inventive cation exchangers may not be known in fall detail, it is likely that the advantageous leaching properties are attributable to the particular network structure.

The present invention therefore provides the use of the inventive cation exchangers
to remove cations, color particles, or organic components from aqueous or organic solutions and condensates, e.g. process condensates or turbine condensates,
for softening of aqueous or organic solutions and condensates, e.g. process condensates or turbine condensates, in a neutral exchange process,
for purification and treatment of water in the chemical industry or electronics industry, and water from power plants,
for demineralization of aqueous solutions and/or condensates, characterized in that these materials are used in combination with anion exchangers of gel type and/or macroporous type,
for decolorization and demineralization of whey, dilute gelatin-containing solutions, fruit juices, fruit must products, and aqueous solutions of sugars.

The present invention also therefore also provides
a process for demineralization of aqueous solutions and/or condensates, e.g. process condensates or turbine condensates, characterized in that inventive monodisperse cation exchangers are used in combination with heterodisperse or monodisperse anion exchangers of gel type and/or of macroporous type,
combinations of inventively produced monodisperse cation exchangers with heterodisperse or monodisperse anion exchangers of gel type and/or of macroporous type for demineralization of aqueous solutions and/or condensates, e.g. process condensates or turbine condensates,
a process for purification and treatment of water in the chemical or electronic industry, or water from power plants, characterized in that the inventive monodisperse cation exchangers are used,
a process for removing cations, color particles, or organic components from aqueous or organic solutions and condensates, e.g. process condensates or turbine condensates, characterized in that the inventive monodisperse cation exchangers are used,
a neutral exchange process for softening aqueous or organic solutions and condensates, e.g. process condensates or turbine condensates, characterized in that the inventive monodisperse cation exchangers are used,
a process for decolorization and demineralization of whey, dilute gelatin-containing solutions, fruit juices, fruit must products, or aqueous solutions of sugars in the sugar industry, starch industry, or pharmaceutical industry, or in dairies, characterized in that the monodisperse cation exchangers produced in the invention are used.

Test Methods

Determination of Stability of Cation Exchangers Via Addition to Alkali

2 ml of sulfonated copolymer in the H form are introduced into 50 ml of 45% strength by weight sodium hydroxide solution, at room temperature with stirring. The suspension is allowed to stand overnight. A representative specimen amount is then removed. 100 beads are inspected under a microscope. The number of perfect, undamaged beads among these is determined.

Determination of Amount of Basic Aminomethyl Groups in an Aminomethylated, Crosslinked Polystyrene Bead Polymer

100 ml of the aminomethylated, crosslinked bead polymer are compacted by shaking under water in as tamping volumeter, and then transferred to a glass column. 1000 ml of 2% strength by weight aqueous sodium hydroxide solution is filtered over the resin in 1 hour and 40 minutes. Demineralized water is then filtered over the resin until 100 ml of the eluate emerging from the resin and mixed with phenolphthalein require not more than 0.05 ml of 0.1 normal hydrochloric acid for titration.

50 ml of the resin are mixed in a glass beaker with 50 ml of demineralized water and 100 ml of 1N hydrochloric acid. The suspension is stirred at room temperature for 30 minutes, and then flushed into a column. The liquid is discharged. Another 100 ml of 1N hydrochloric acid are filtered over the resin in 20 minutes. 200 ml of methanol are then filtered over the resin. All of the eluates are collected and combined and titrated against 1N aqueous sodium hydroxide solution, using methyl orange as indicator.

The amount of aminomethyl groups in 1 liter of the aminomethylated crosslinked polystyrene bead polymer is calculated via the following formula:
(200−V)×20=mol of aminomethyl groups per liter of resin

Determination of Degree of Substitution of the Aromatic Rings in Crosslinked Polystyrene Bead Polymer Via Aminomethyl Groups

The amount of aminomethyl groups in the entire amount of resin is determined by the above method.

The molar amount of aromatic rings in the bead polymer is calculated by dividing the amount of bead polymer by the molecular weight.

180 g of bead polymer are used for production of 568 ml of aminomethylated crosslinked polystyrene bead polymer having 1.38 mol of aminomethyl groups.

568 ml of aminomethylated crosslinked polystyrene bead polymer contain 1.69 mol of aromatic rings. Each aromatic ring then includes 1.38/1.69=0.82 mol of aminomethyl groups.

The degree of substitution of the aromatic rings in the crosslinked polystyrene bead polymer is then 0.82.

Number of Perfect Beads After Production

100 beads are inspected under a microscope. The number of beads which are cracked or splintered is determined. The number of perfect beads is calculated from the difference between 100 and the number of damaged beads.

Roll-Test Determination of Resin Stability

The bead polymer to be tested is distributed between two synthetic cloths to give uniform layer thickness. The cloths are placed on a firm horizontal substrate and subjected to 20 cycles in a roll apparatus. A cycle is composed of one advancement and return of the roll. The number of undamaged beads is determined after rolling, via counting under a microscope, using representative samples, each of 100 beads.

Swelling Stability Test

25 ml of anion exchanger in the chloride form are charged to a column. 4% strength by weight aqueous sodium hydroxide solution, demineralized water, 6% strength by weight hydrochloric acid, and again demineralized water are added in succession to the column, the sodium hydroxide solution and the hydrochloric acid flowing through the resin from above, and the demineralized water being pumped through the resin from below. The treatment takes place in time cycles by way of a control device. One cycle takes 1 h. 20 cycles are carried out. Once the cycles have ended, 100 beads are counted out from the resin sample. The number of perfect beads not damaged by cracking or splintering is determined.

Determination of Amount of Weakly and Strongly Basic Groups in Anion Exchangers

100 ml of anion exchanger are treated with 1000 ml of 2% strength by weight sodium hydroxide solution in a glass column in 1 hour and 40 minutes. The resin is then washed with demineralized water to remove excess sodium hydroxide solution.

Determination of NaCl Number

50 ml of the exchanger in the free base form, and washed until neutral, are placed in a column and treated with 950 ml of 2.5% strength by weight aqueous sodium chloride solution. The eluate is collected, made up to 1 liter with demineralized water, and 50 ml of the material are titrated with 0.1N hydrochloric acid (=0.1 normal hydrochloric acid). The resin is washed with demineralized water.
Consumption in ml of 0.1N hydrochloric acid'4/100=NaCl number in mol/liter of resin.

Determination of NaNO₃ Number

950 ml of 2.5% strength by weight sodium nitrate solution are then filtered over the material. The eluate is made up to 1000 ml with demineralized water. An aliquot of this material is taken—10 ml—and its chloride content is determined via titration with mercurous nitrate solution.
Consumption in ml of Hg(NO₃) solution×factor/17.75=NaNO₃ number in mol/liter of resin.

Determination of HCl Number

The resin is washed with demineralized water and flushed into a glass beaker. It is treated with 100 ml of 1N hydrochloric acid and allowed to stand for 30 min. The entire suspension is flushed into a glass column. A further 100 ml of hydrochloric acid are filtered over the resin. The resin is washed with methanol. The eluate is made up to 1000 ml with demineralized water. 50 ml of this material are titrated with 1N sodium hydroxide solution.
(20−consumption in ml of 1N sodium hydroxide solution)/5=HCl number in mol/liter of resin.

The amount of strongly basic groups is equal to the total of NaNO₃ number and HCl number.

The amount of weakly basic groups is equal to the HCl number.

Determination of the Amount of Chelating Groups in the Chelating Resin—Determination of Total Capacity

100 ml of chelating resin to be studied are charged to a glass column and eluted with 3% strength by weight hydrochloric acid in 1.5 hours. The material is then washed with demineralized water until the eluate is neutral.

50 ml of chelating resin to be studied are charged to a glass column and treated with 0.1 normal sodium hydroxide solution. The eluate is collected in a 250 ml glass flask, and the entire amount is titrated against normal hydrochloric acid, using methyl orange.

The treatment with normal sodium hydroxide solution continues until 250 ml of eluate require from 24.5 to 25 ml of normal hydrochloric acid. Once the test has ended, the volume of the exchanger in the Na form is determined.
Total capacity (TC)=8X·25−Σ V)−3 in mol/liter of exchanger

X=number of eluate fraction

Σ V=total consumption in ml of normal hydrochloric acid during titration of eluates.

### EXAMPLES

### Example 1

a) Preparation of a Seed Polymer

2325 g of n-butanol, 75 g of toluene, 180 g of polyvinylpyrrolidone (Luviskol K30) are stirred for 20 min in a 4-1 three-necked flask flushed with a stream of 20 l/h of nitrogen, giving a homogeneous solution. 300 g of styrene, 3.75 g of the sodium salt of isooctyl sulfosuccinate, and 4.5 g of resorcinol are then added, while continuing stirring at 150 rpm (revolutions per minute), and the mixture is heated to 80° C. A solution composed of 3 g of azodiisobutyric acid and 117 g of n-butanol and temperature-controlled to 40° C. is added all at once to the mixture, and the mixture is kept at 80° C. for 20 h. The reaction mixture is then cooled to room temperature, and the resultant polymer is isolated via centrifuging and washed twice with methanol and twice with water. This gives 950 g of an aqueous dispersion with solids content of 20% by weight. The particle size is 4.5 μm, Ø (90)/Ø (10) is 1.08.

b1) First Feed Step

300 g of styrene, 9.24 g of 75% strength by weight dibenzoyl peroxide, 500 g of water, 3.62 g of ethoxylated nonylphenol (Arkopal N060), 0.52 g of the sodium salt of isooctyl sulfosuccinate, and 2 g of 3,3′,3″,5,5′,5″-hexa-tert-butyl-α,α′,α″-(mesitylene-2,4,6-triyl)tri-p-cresol (Irganox 1330 inhibitor) are used to produce a fine-particle emulsion I in a plastics container with an Ultraturrax (3 min, speed 13 500).

A solution composed of 5 g of methylhydroxyethylcellulose in 2300 g of demineralized water, and 200 g of aqueous dispersion from a) is charged to a 4-1 three-necked flask, flushed with a 20 l/h stream of nitrogen. At room temperature, the fine-particle emulsion I is added via a pump within a period of 3 hours at constant rate, with stirring. The mixture is then kept at room temperature for 3 further hours and then is heated to 80° C. for 9 hours. The reaction mixture is then cooled to room temperature, and the resultant polymer is isolated via centrifuging and washed twice with water, and dispersed in water. This gives 1500 g of an aqueous dispersion with solids content of 20% by weight. The particle size is 8.8 μm, Ø (90)/Ø (10) is 1.10.

b2) Second Feed Step

288 g of styrene, 12 g of 80% strength by weight divinylbenzene, 9.24 g of dibenzoyl peroxide, 500 g of water, 3.62 g of ethoxylated nonylphenol (Arkopal N060), 0.52 g of the sodium salt of isooctyl sulfosuccinate, and 2 g of 3,3′,3″,5,5′,5″-hexa-tert-butyl-α,α′,α″-(mesitylene-2,4,6-triyl)tri-p-cresol (Irganox 1330 inhibitor) are used to produce a fine-particle emulsion in a plastics container with an Ultraturrax (3 min, speed 13 500).

c)

A solution composed of 5 g of methylhydroxyethylcellulose in 2300 g of demineralized water, and 200 g of aqueous dispersion from b1) is charged to a 4-1 three-necked flask, flushed with a 20 l/h stream of nitrogen. At room temperature, the fine-particle emulsion from b2) is added via a pump within a period of 3 hours at constant rate, with stirring. The mixture is then kept at room temperature for 3 further hours and then is heated to 80° C. for 9 hours. The reaction mixture is then cooled to room temperature, and the resultant polymer is isolated via centrifuging and washed three times with water, and dried at 80° C. This gives 312 g of bead polymer with a particle size of 16 μm, Ø (90)/Ø (10) is 1.15.

d) Production of a Cation Exchanger

900 ml of 97.32% strength by weight sulfuric acid are used as initial charge in a 2-1 four-necked flask and are heated to 100° C. A total of 200 g of dry copolymer from c) are introduced in 10 portions in 4 hours, with stirring. The mixture is then stirred for a further 4 hours at 100° C. After cooling, the suspension is transferred to a glass column. Sulfuric acids of reducing concentration levels are filtered through the column from above, starting with 90% by weight and finishing with pure water. This gives 1090 ml of cation exchanger in the H form. The particle size is 20 μm, Ø (90)/Ø (10) is 1.15.

| | |
|---|---|
| Stability test/addition to alkali | 100/100 |
| Number of perfect beads | |

### Example 2

a) Preparation of a Seed Polymer

A monodisperse seed polymer with a particle size of 4.5 μm is prepared as in example 1 a).

b1) First Feed Step

300 g of styrene, 9.24 g of 75% strength by weight dibenzoyl peroxide, 500 g of water, 3.62 g of ethoxylated nonylphenol (Arkopal N060), 0.52 g of the sodium salt of isooctyl sulfosuccinate, and 2 g of 3,3′,3″,5,5′,5″-hexa-tert-butyl-α,α′,α″-(mesitylene-2,4,6-triyl)tri-p-cresol. (Irganox 1330 inhibitor) are used to produce a fine-particle emulsion I in a plastics container with an Ultraturrax (3 min, speed 13 500).

A solution composed of 5 g of methylhydroxyethylcellulose in 2300 g of demineralized water, and 200 g of aqueous dispersion from a) is charged to a 4-1 three-necked flask, flushed with a 20 l/h stream of nitrogen. At room temperature, the fine-particle emulsion I is added via a pump within a period of 3 hours at constant rate, with stirring. The mixture is then kept at room temperature for 3 further hours and then is heated to 80° C. for 9 hours. The reaction mixture is then cooled to room temperature, and the resultant polymer is isolated via centrifuging and washed twice with water and dispersed in water. This gives 1500 g of an aqueous dispersion with solids content of 20% by weight. The particle size is 8.5 μm, Ø (90)/Ø (10) is 1.10.

b2) Second Feed Step

A second feed step is carried out, maintaining the conditions for the first feed step and using 813.38 g of emulsion I and 200 g of the aqueous dispersion from b1). The resultant bead polymer is washed and dried. This gives 308 g of bead polymer with a particle size of 15.5 μm. Ø (90)/Ø (10) is 1.15.

b3) Third Feed Step

A third feed step is carried out, maintaining the conditions for the second feed step and using 813.38 g of emulsion I and 40 g of the bead polymer from b2). The resultant bead polymer is washed and dried. This gives 315 g of bead polymer with a particle size of 26 μm. Ø (90)/Ø (10) is 1.15.

b4) Fourth Feed Step

A fourth feed step is carried out, maintaining the conditions for the third feed step and using 813.38 g of emulsion I and 40 g of the bead polymer from b3). The resultant bead polymer is washed and dried. This gives 318 g of bead polymer with a particle size of 49 μm. Ø (90)/Ø (10) is 1.18.

b5) Fifth Feed Step

A fifth feed step is carried out, maintaining the conditions for the fourth feed step and using 813.38 g of emulsion II composed of 270 g of styrene, 30 g of 80% strength by weight divinylbenzene, 9.24 g of dibenzoyl peroxide, 500 g of water, 3.62 g of ethoxylated nonylphenol (Arkopal N060), 0.52 g of the sodium salt of isooctyl sulfosuccinate, and 2 g of 3,3′,3″,5,5′,5″-hexa-tert-butyl-α,α′,α″-(mesitylene-2,4,6-triyl)tri-p-cresol (Irganox 1330 inhibitor), and 40 g of bead polymer from b4). The resultant bead polymer is washed and dried. This gives 325 g of bead polymer with a particle size of 99 μm, Ø (90)/Ø (10) is 1.2.

e) Production of a Cation Exchanger

900 ml of 98% strength by weight sulfuric acid are used as initial charge at room temperature in a 2-1 four-necked flask. 200 g of dry copolymer from b5) are metered in within a period of 15 min, with stirring. The mixture is then heated to 120° C. in 3 h and stirred at 120° C. for a further 4 hours. After cooling, the suspension is transferred to a glass column. Sulfuric acids of reducing concentration levels are filtered through the column from above, beginning with 80% by weight and finishing with pure water. This gives 950 ml of cation exchanger in the H form. The particle size is 150 μm, Ø (90)/Ø (10) is 1.15.

| | |
|---|---|
| Stability test/addition to alkali | 99/100 |
| Number of perfect beads | |

### Example 3

Preparation of a Weakly Basic and Strongly Basic Anion Exchanger

Apparatus:

Four-necked flask, water separator, thermometer, dropping funnel, pH electrode, pH-controlled pump, condenser.

3a) N-Methylolphthalimide

853.6 g of 1,2-dichloroethane, 279.2 of phthalimide, and 201.1 g of formalin (28.9% strength by weight, based on formaldehyde) are used as initial charge at room temperature. The mixture is heated to reflux temperature. Once this temperature has been reached, a pH-controlled pump is used to adjust the pH to 5.5-6, by means of 50% strength by weight sodium hydroxide solution. 30 minutes after a cloudy solution has been produced, a specimen is taken and the composition is analyzed by thin-layer chromatography.

N-Methylolphthalimide: 95.0%

Phthalimide: 3%

Phthalic acid: 2%

3b) bis(Phthalimidomethyl)ether

After all of the water present in the reaction mixture has been removed in the separator, 20.5 g of sulfuric acid monohydrate are fed. Once the feed has ended, the solution obtained is clear. The water which forms in the reaction which then follows is removed by the separator. A specimen is then taken and the composition is analyzed by thin layer chromatography.

N-Methylolphthalimide: 2.6%

Phthalimide: 5.5%

Phthalic acid: 1.6%

bis(Phthalimidomethyl) ether: 90.3%

3c) N-Acetoxymethylphthalimide

The resultant suspension of bis(phthalimidomethyl) ether is temperature-controlled to 60° C. 96.9 g of acetic anhydride are then fed within a period of 5 minutes. After the feed has ended, the solution obtained is clear. The mixture is stirred for 15 minutes at 60° C. and then heated to 80° C. and stirred at this temperature for 10 minutes. A specimen is then taken and the composition is analyzed by thin layer chromatography.

N-Methylolphthalimide: 2%

Phthalimide: 4.5%

Phthalic acid: 2%

bis(Phthalimidomethyl) ether: 0.2%

N-Acetoxymethylphthalimide: 91.3%

3d) Condensation of N-acetoxymethylphthalimide with Bead Polymer

The resultant solution of N-acetoxymethylphthalimide is cooled to 45-50° C. 180 g of feed polymer from example 2b5 are then fed in 30 minutes. The mixture is stirred at 45-50° C. for 30 minutes. 71.9 g of sulfuric acid monohydrate are then fed within a period of one hour. The mixture is heated to 80° C. in 45 minutes and stirred at this temperature for 7 hours. After cooling, the bead polymer is transferred to a glass frit suction filter. The condensation solution is removed by suction. The bead polymer is washed repeatedly with methanol. The bead polymer is then introduced into 1820 ml of 20% strength by weight aqueous sodium chloride solution. The suspension is heated to reflux temperature and remaining 1,2-dichloroethane and methanol is removed by distillation. The resultant bead polymer is cooled and then washed with water.

Resin yield: 650 ml

3e) Treatment of Phthalimidomethylated Bead Polymer with Ammonia Solution

650 ml of phthalimidomethylated bead polymer and 592 g of ammonia solution are used as initial charge at room temperature in a flask and are heated to 90° C., and stirred at this temperature for 4 h.

After cooling, the resin is washed with water.

Resin yield: 635 ml

Elemental analysis of composition:

carbon: 76.1% by weight

hydrogen: 5.1 % by weight

nitrogen: 5.0% by weight

oxygen: 13.8% by weight

3f) Reaction of Phthalimidomethylated Bead Polymer with Sodium Hydroxide Solution for Preparing Aminomethylated Bead Polymer for Weakly Basic Anion Exchanger

610 ml of resin from 3e) and 281 g of 50% strength by weight sodium hydroxide solution are used as initial charge at room temperature in an autoclave and are heated to 180° C. within a period of 2 hours, with stirring. The mixture is stirred at 180° C. for 6 hours. After cooling, the resin is washed with water.

Resin yield: 550 ml

carbon: 81.7% by weight

hydrogen: 8.1% by weight

nitrogen: 7.7% by weight

oxygen: 2.5%-by weight

HCl number: 2.43 mol/l

Substitution: 0.82

Stability:

Original condition: 99% of entire beads

After roller test: 97% of entire beads

After swelling stability: 98% of entire beads

3g) Reaction (Quaternization) of Aminomethylated Bead Polymer with Chloromethane to Give Strongly Basic Anion Exchanger

320 ml of aminomethylated bead polymer, 538 ml of demineralized water, and 179.7 g of 500/? strength by weight sodium hydroxide solution are used as initial charge at room temperature in an autoclave. 144 g of chloromethane are then fed into the autoclave. The mixture is heated to 40° C. and stirred at this temperature for 16 hours. The stirrer speed is 400 rpm.

After cooling, the resin is washed on a sieve until neutral and transferred to a glass column. 3% strength by weight aqueous hydrochloric acid are filtered over the material from above.

Resin yield: 530 ml

HCl number: 0.08 mol/l

NaCl number: 1.35 mol/l

NaNO₃ number: 0.96 mol/l

Stability:

Original condition: 99% of entire beads

After roller test: 98% of entire beads

After swelling stability: 98% of entire beads

### Example 4

Production of a Chelating Resin having Iminodiacetic Acid Groups

500 ml of a weakly basic anion exchanger produced as in example 3f) are suspended in 800 ml of demineralized water. 339.8 g of sodium monochloroacetate are fed into the suspension in 30 minutes. The mixture is stirred at room temperature for a further 30 minutes. The pH of the suspension is then set to pH 10, using 20% strength by weight sodium hydroxide solution. The suspension is then heated to 80° C. within a period of 2 hours. The mixture is then stirred at this temperature for a further 10 hours. The pH is kept at 10 during this time via feed of 20% strength by weight sodium hydroxide solution.

After cooling, the resin is filtered off and washed with demineralized water until free from chloride.

Resin yield: 928 ml

Total capacity of resin: 2.53 mol/l

What is claimed is:

1. A process for producing monodisperse ion-exchanger gels with a particle size of from 5 to 500 μm, characterized in that
a) a non-crosslinked monodisperse seed polymer (with a particle size of from 0.5 to 20 μm) is produced via free-radical-initiated polymerization of monoethylenically unsaturated compounds in the presence of a non-aqueous solvent,
b) an activated styrene-containing monomer mixture is added as feed to this seed polymer, the monomer mixture is permitted to penetrate and swell the seed, and the mixture is polymerized at an elevated temperature, and the steps of addition of monomer mixture, penetration and swelling, and polymerization are, if appropriate, repeated one or more times, and where during the final addition the monomer mixture comprises from 2 to 50% by weight of crosslinking agent, and
c) the resultant polymer is converted via functionalization into ion exchanger.

2. The process as claimed in claim 1, characterized in that cation exchangers are produced via sulfonation in step c) of the process.

3. The process as claimed in claim 1, characterized in that anion exchangers are produced via amidomethylation with subsequent hydrolysis in step c) of the process.

4. A monodisperse ion-exchanger gel with a particle size of from 5 to 500 μm, obtainable via
a) production of a non-crosslinked monodisperse seed polymer with a particle size of from 0.5 to 20 μm via free-radical-initiated polymerization of monoethylenically unsaturated compounds in the presence of a non-aqueous solvent,
b) addition of an active styrene-containing monomer mixture as feed to this seed polymer, permitting the monomer mixture to penetrate into and swell the seed, and polymerizing the mixture at an elevated temperature, if appropriate with one or more repetitions of the steps of addition of monomer mixture, penetration and swelling, and polymerization, and where during the final addition the monomer mixture comprises from 2 to 50% by weight of crosslinking agent, and
c) functionalization by means of a sulfonating agent to give cation exchangers or via amidomethylation with subsequent hydrolysis to give anion exchangers, or chloromethylation with subsequent amination.
